(19) United States
(12) Patent Application Publication
(10) Pub. No.: US 2016/0266385 A1
(43) Pub. Date: Sep. 15, 2016

(54) SYSTEM FOR DISPLAYING AN IMAGE ON A WINDSCREEN

(71) Applicant: COMMISSARIAT A L'ENERGIE ATOMIQUE ET AUX ENERGIES ALTERNATIVES, Paris (FR)

(72) Inventor: Umberto ROSSINI, Coublevie (FR)

(21) Appl. No.: 15/033,977

(22) PCT Filed: Nov. 4, 2014
(86) PCT No.: PCT/FR2014/052804

§ 371 Date: May 3, 2016

(30) Foreign Application Priority Data
Nov. 18, 2013 (FR) 1361286

(51) Int. Cl. G02B 27/01; G03B 21/13; G03B 21/625; G03B 29/00

(52) U.S. Cl. CPC G02B 27/0103; G03B 29/00; G03B 21/13; G03B 21/625

(57) ABSTRACT

An assembly comprises a vehicle windscreen, and a stack of first and second films at least partially coating a face of the windscreen, the first film being arranged between the windscreen and the second film, wherein: the second film is a screen suitable for displaying an image projected on the face thereof opposite the windscreen; and the first film is a reflector suitable for reflecting light transmitted by the second film towards the windscreen.

The present patent application claims the priority benefit of French patent application FR13/61286 which is herein incorporated by reference.

### BACKGROUND

The present disclosure relates to the displaying of an image on the windshield of a motor vehicle.

### DISCUSSION OF THE RELATED ART

Systems where an image is projected on a transparent diffusing film pasted on the windshield inside of the vehicle have already been provided. Such systems enable to give an occupier of the vehicle information overlaid on the outer scene visible through the windshield.

Existing systems however have various disadvantages. In particular, a disadvantage is that part of the light projected on the transparent diffusing film is transmitted by the film, crosses the windshield, and is projected outside of the vehicle. This raises issues in certain applications. In particular, this makes existing systems incompatible with certain vehicles, for example, military vehicles where, for confidentiality reasons, it is not acceptable for the information projected for the occupiers of the vehicle to be readable from the outside of the vehicle. This further makes existing systems incompatible with certain stealth vehicles where the light transmitted through the transparent diffusing film and the windshield could make the vehicle easily detectable.

It would be desirable to have a windshield image display system which at least partly overcomes some of the disadvantages of existing systems.

### SUMMARY

Thus, an embodiment provides a system for displaying an image on a windshield of a vehicle, comprising: a stack of first and second films at least partially coating a surface of the windshield, the first film being arranged between the windshield and the second film; and a projector capable of projecting an image onto the surface of the second film opposite to the windshield, wherein: the second film is a reflective diffuser screen or a photoluminescent film capable of displaying said image in a first range of visible wavelengths; and the first film is a reflector capable of reflecting at least 50% and preferably at least 90% of the light transmitted by the second film towards the windshield in said first wavelength range.

According to an embodiment, the first and second films are transparent for light coming from the windshield.

According to an embodiment, the second film is a reflective diffuser screen, and the projector only emits in said first wavelength range.

According to an embodiment, the second film is a photoluminescent film capable, when it is excited by rays at at least one activation wavelength which does not belong to the first wavelength range, of emitting light only in said first wavelength range, and wherein the projector is capable of emitting at said at least one activation wavelength.

According to an embodiment, the first film is a holographic film.

According to an embodiment, the first film is only reactive to the wavelengths of said first wavelength range, and is transparent for the other wavelengths.

According to an embodiment, said first wavelength range has a spectral width smaller than 50 nm.

According to an embodiment, the windshield is an armored windshield.

According to an embodiment, the projector is a laser projector.

According to an embodiment, the system further comprises a blurring element arranged between the projector and the second film.

According to an embodiment, the blurring element is a permanent diffuser arranged to intercept a portion only of a beam projected by the projector onto the second film.

According to an embodiment, the blurring element is a diffuser which may be activated and deactivated by electric control, arranged to totally intercept a beam projected by the projector onto the second film.

### BRIEF DESCRIPTION OF THE DRAWINGS

The foregoing and other features and advantages will be discussed in detail in the following non-limiting description of specific embodiments in connection with the accompanying drawings, among which:

FIG. 1 is a simplified cross-section view illustrating an embodiment of a system for displaying an image on a windshield;

FIG. 2 is a simplified cross-section view illustrating another embodiment of a system for displaying an image on a windshield;

FIG. 3 is a simplified cross-section view illustrating an alternative embodiment of system for displaying an image on a windshield;

FIG. 4 very schematically shows an example of an image likely to be displayed on a windshield by the system of FIG. 3; and

FIG. 5 is a simplified cross-section view illustrating another alternative embodiment of system for displaying an image on a windshield.

### DETAILED DESCRIPTION

For clarity, the same elements have been designated with the same reference numerals in the various drawings and, further, the various drawings are not to scale. Further, in the following description, unless otherwise indicated, terms “approximately”, “substantially”, “about”, “almost”, and “in the order of” mean “to within 10%”. Further, in the present patent application, unless otherwise indicated, term transparent is used to qualify elements, materials, films, assemblies, etc. letting through, with no significant alteration, the light of the visible spectrum or of almost the entire visible spectrum.

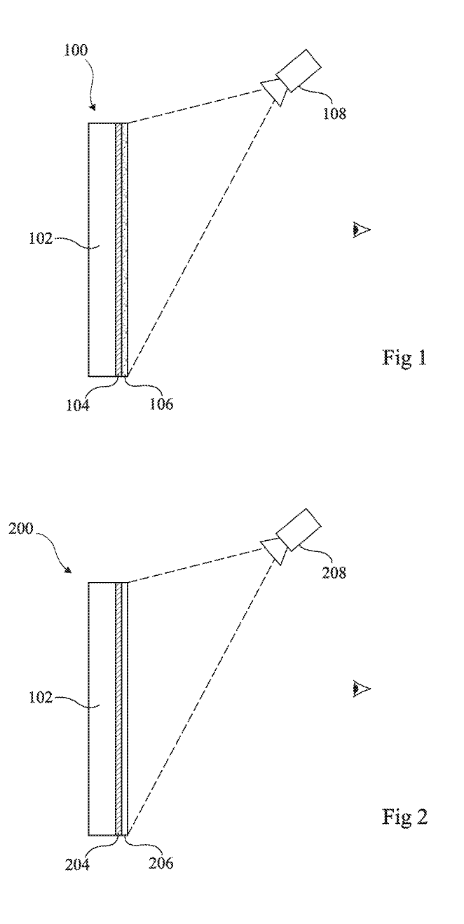

FIG. 1 is a simplified cross-section view illustrating an embodiment of a system 100 for displaying an image on a transparent windshield 102.

In this example, system 100 comprises an assembly comprising the actual windshield 102, and a stack of two films 104 and 106 coating the inner surface of windshield 102, that is, the surface of windshield 102 directed towards the inside of the vehicle. Film 104 is placed between windshield 102 and film 106. In this example, film 104 is pasted on the inner surface of windshield 102 and film 106 is pasted on the surface of film 104 opposite to windshield 102. In the shown example, the stack formed by films 104 and 106 substantially coats the entire surface of windshield 102. The described embodiments are however not limited to this specific case.

Windshield 102 may have a single-layer structure or a multi-layer structure. It may comprise glass, polycarbonate, or any other transparent material capable of being used to form a windshield. As an example, windshield 102 is an armored windshield made of laminated glass having a thickness in the range from 2 to 12 cm, formed by a stacking of a plurality of glass layers separated two by two by polyvinyl butyral (PVB) interlayers. In front view, windshield 102 for example has a rectangular shape.

System 100 further comprises a projector 108 located inside of the vehicle and arranged to enable to project an image onto all or part of the surface of film 106 opposite to windshield 102 (that is, directed towards the inside of the vehicle). Projector 108 preferably is a projector enabling to display information with a relatively high luminance (especially to obtain a good visibility, even in broad daylight), and on areas of relatively small dimensions (to avoid disturbing the vision of the external scene). Projector 108 for example comprises a laser source coupled to a vector scan device, or an active array based on light-emitting diodes coupled to an optical projection system, or one or a plurality of light-emitting diodes coupled to an optical focusing waveguide and to a vector scan device. Preferably, projector 108 emits in a relatively narrow wavelength range, for example, with a spectral width smaller than 50 nm.

According to an aspect of the embodiment of FIG. 1, film 106 is a reflective diffuser film capable of reflecting, by more or less strongly diffusing it, the light from projector 108, without altering the light coming from windshield 102 (that is, from the outside of the vehicle). Film 106 thus forms a display screen transparent for the light coming from the outside of the vehicle. Film 106 may be monolayer or multilayer. Film 106 may comprise a transparent layer having a surface comprising microstructures, for example, lenticular, with a shape capable of only diffusing the light reflected by this surface, without altering the transmitted light. The microstructures may be coated with a thin semi-transparent metal layer favoring the reflection of the light coming from the inside of the vehicle while letting through the most part of the light coming from the outside. Other types of transparent reflective diffuser films may be used, for example, films of the type commercialized by LUMINIT under trade name “Light Shaping Diffuser”, films of the type described in the article entitled “Microstructured head-up display screen for automotive applications” of Hedili et al., holographic diffuser films, etc.

When projector 108 illuminates film 106, part of the light originating from projector 108 is neither reflected nor absorbed by film 106, but is transmitted towards film 104.

According to another aspect of the embodiment of FIG. 1, film 104 is a reflective film capable of reflecting the most part of (at least 50%), and preferably all or almost all (at least 90%) the light originating from projector 108 and transmitted by film 106, without significantly altering the light coming from the outside of the vehicle. In other words, film 104 is capable of reflecting at least half and preferably at least 90% of the luminous power transmitted by film 106 at the emission wavelengths of projector 108. Film 104 thus forms a reflector transparent for light coming from the outside. Film 104 for example is a holographic film comprising a Bragg mirror grating capable of reflecting all or almost all the light coming from the inside of the vehicle at the wavelengths emitted by projector 108. Holographic film 104 is preferably non reactive to wavelengths other than those emitted by projector 108, that is, it is substantially transparent in both directions for these wavelengths. The light coming from the outside of the vehicle at wavelengths for which film 104 is reactive may be slightly attenuated by film 104, but is neither deformed nor totally stopped by film 104. To limit the attenuation, by film 104, of the light coming from the outside, a projector 108 and a corresponding film 104 operating at wavelengths which are little or not present in the external scene are preferably selected. Further, a projector 108 and a corresponding film 104 only operating in a narrow wavelength range, for example, a spectral band having a width at half maximum smaller than 50 nm, is preferably selected. As an example, projector 108 is a monochromatic laser projector, and film 104 is only active at the emission wavelength of projector 108.

Thus, in practice, film 104 does not alter, or only alters by negligible proportions, the information coming from the outside.

Other types of films capable of reflecting all or almost all the light coming from the inside of the vehicle at the wavelength ranges emitted by projector 108, without altering the information originating from the outside, may be used, for example, a non-holographic film comprising a Bragg mirror grating.

FIG. 2 is a simplified cross-section view illustrating another embodiment of a system 200 for displaying an image on a transparent windshield 102.

In this example, system 200 comprises an assembly comprising the actual windshield 102, which may be identical or similar to that of system 100 of FIG. 1, and a stack of two films 204 and 206 coating the inner surface of windshield 102, film 204 being placed between windshield 102 and film 206. In this example, film 204 is pasted on the inner surface of windshield 102 and film 206 is pasted to the surface of film 204 opposite to windshield 102. In the shown example, the stack formed by films 204 and 206 substantially coats the entire surface of windshield 102. The described embodiments are however not limited to this specific case.

System 200 further comprises a projector 208 located inside of the vehicle and arranged to enable to project an image onto all or part of the surface of film 206 opposite to windshield 102 (that is, directed towards the inside of the vehicle). Projector 208 for example comprises a laser source coupled to a vector scan device, or one or a plurality of light-emitting diodes coupled to an optical focusing system and to a vector scan device. Preferably, projector 108 emits in a relatively narrow wavelength range, for example, having a spectral width smaller than 50 nm.

According to an aspect of the embodiment of FIG. 2, film 206 is a transparent photoluminescent film, that is, a transparent film comprising photoluminescent particles capable of emitting light at a specific visible wavelength, called emission wavelength, when they are excited by rays at another specific wavelength, called activation wavelength. The light emitted by film 206 may be monochromatic, for example, red, green, or blue. The activation wavelength of film 206 is preferably located outside of the visible spectrum, for example, in ultraviolet. As an example, film 206 is a film of the type commercialized by SUN INNOVATIONS under trade name “TRANSPLAY”, which may be activated by rays having an approximate 405-nm wavelength, and emitting red light when it is activated.

Projector 208 is capable of emitting at the activation wavelength of film 206. In operation, projector 208 projects on film 206 an image at the activation wavelength of the film. The photons emitted by projector 208 are absorbed by film 206 which, in return, emits photons at its emission wavelength. This causes the display, on film 206, at the emission wavelength of the film, of the image (possibly invisible) projected by projector 208 at the film activation wavelength.

For wavelengths other than its activation wavelength, film 206 is transparent. Thus, it does not alter the information coming from the outside of the vehicle. Film 206 thus forms a display screen transparent for light coming from the outside of the vehicle.

It should be noted that if a multiple-color display system is desired to be formed, film 206 may comprise a plurality of superposed transparent photoluminescent films, emitting at different wavelengths and capable of being activated by different wavelengths. Projector 208 is then selected to be capable of emitting at the different activation wavelengths of the film.

When projector 208 illuminates film 206, part of the visible light generated by the film is emitted towards film 204, that is, towards the outside of the vehicle.

According to another aspect of the embodiment of FIG. 2, film 204 is a reflective film capable of reflecting the most part (at least 50%), and preferably all or almost all (at least 90%) the light emitted by film 206 towards the outside of the vehicle, without altering the light coming from the outside of the vehicle. In other words, film 204 is capable of reflecting at least half and preferably at least 90% of the luminous power coming from film 206 at the emission wavelengths of film 206. Film 204 thus forms a reflector transparent for light coming from the outside. Film 204 for example is a holographic film capable of reflecting all or almost all the light coming from the inside of the vehicle at the emission wavelengths of film 206. Holographic film 204 is preferably non reactive to wavelengths other than the emission wavelengths of film 206, that is, it is substantially transparent in both directions for such wavelengths. The light coming from the outside of the vehicle at the wavelengths at which film 204 is reactive may be slightly attenuated by film 204, but is neither deformed nor totally stopped by film 204. To limit the attenuation, by film 204, of the light coming from the outside of the vehicle, a film 206 and a corresponding film 204 only active at wavelengths which are little or not present in the external scene are preferably selected. Further, a film 206 and a corresponding film 204 only active in a narrow wavelength range, for example, a spectral band having a width at half maximum smaller than 50 nm, is preferably selected.

Thus, in practice, film 204 does not alter, or only alters by negligible proportions, the information coming from the outside.

Other types of films capable of reflecting all or almost all the light coming from the inside of the vehicle at the wavelength ranges emitted by film 206, without altering the information coming from the outside, may be used, for example, a non-holographic film comprising a Bragg mirror grating.

An advantage of the embodiments described in relation with FIGS. 1 and 2 is that they enable to display, on a motor vehicle windshield, information for an occupier of the vehicle, without for the light used to display this information to be detectable outside of the vehicle, and without altering the information coming from the outside.

It should be noted that to obtain a display of strong luminosity inside of the vehicle, and although the described embodiments are not limited to this specific case, projectors 108 and 208 of the embodiments of FIGS. 1 and 2 are preferably vector scan-type projectors.

However, although vector scan projectors are well adapted to displaying patterns with sharp edges, they are generally poorly adapted to displaying patterns having blurred edges.

However, in certain applications, it is desired to be able to display on the windshield both patterns with sharp edges and patterns with blurred edges. As an example, patterns with sharp edges may be displayed in peripheral areas of the windshield to provide information such as the speed of the vehicle, its position, etc. Patterns with blurred edges may for example be used in a central area of the windshield in augmented reality applications. In particular, to attract the user's attention on an element of the real outside scene visible through the windshield, for example, a pedestrian, a traffic sign, another vehicle, etc., it may be provided to display on the windshield a pattern with blurred edges which is overlaid on this real element, to obtain an effect of highlighting or zoning of the real element. The use of a pattern with blurred edges rather than of a pattern with sharp edges then has the advantage of not compelling the user to accommodate his/her vision on the windshield, and of enabling him/her to keep his/her attention on the outside scene.

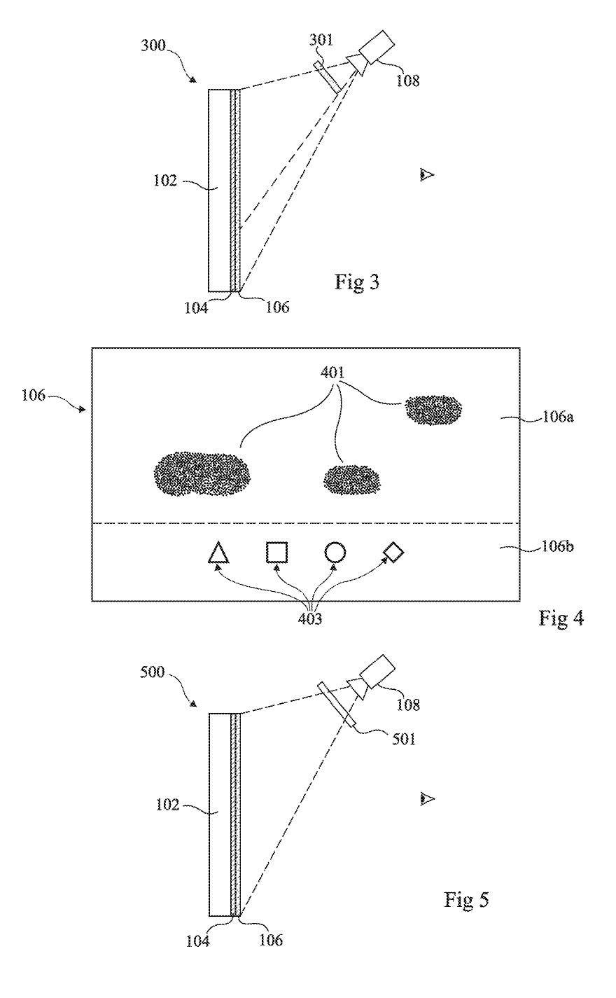

FIG. 3 is a simplified cross-section view illustrating an example of an alternative embodiment of a system for displaying an image on a windshield, enabling to display an image comprising both patterns with sharp edges and patterns with blurred edges.

Display system 300 of FIG. 3 comprises the same elements as display system 100 of FIG. 1. Projector 108 for example is a vector scan projector. System 300 further comprises, between projector 108 and film 106, a transmissive diffuser 301, that is, a sheet, plate, or film, transmitting, towards its surface directed towards film 106, the light illuminating its face directed towards projector 108, by more or less diffusing this light. Diffuser 301 is arranged to intercept a portion, but not all, of the light ray beam emitted by projector 108 towards film 106. Thus, in operation, a portion 106a of film 106 receives rays emitted by projector 108 and crossing diffuser 301, and a portion 106b of film 106 receives rays emitted by projector 108 and which do not cross diffuser 301. Diffuser 301 thus forms a blurring element enabling to transform patterns with sharp edges generated by projector 108 into patterns with blurred edges. Thus, area 106a of film 106 may display patterns with blurred edges, and area 106b of film 106 may display patterns with sharp edges.

FIG. 4 is a front view of film 106, very schematically showing an example of an image capable of being displayed by the system of FIG. 3.

As appears in FIGS. 3 and 4, in this example, diffuser 301 is arranged so that portions 106a and 106b of film 106 have the shape of parallel adjacent rectangular strips, respectively occupying an upper portion and a lower portion of windshield 102 (in the orientation of the drawings). In the shown example, portion 106b occupies the most part of windshield 102. The described embodiments are however not limited to this specific arrangement of diffuser 301. As a variation, diffuser 301 may be arranged so that portion 106a of film 106 has the shape of a rectangular ring occupying a peripheral region of windshield 102, and that portion 106b has the shape of a rectangle occupying the central portion of the windshield. Other layouts of diffuser 301 may of course be envisaged.

FIG. 4 shows, on portion 106a of film 106, blurred spots 401 corresponding to patterns with sharp edges generated by projector 108 and blurred by diffuser 301, and, on portion 106b of film 106, pictograms 403 with sharp edges, corresponding to patterns generated by projector 108 in a portion of the projection beam which does not cross diffuser 301.

FIG. 5 is a simplified cross-section view illustrating an example of another alternative embodiment of a system for displaying an image on a windshield, enabling to display an image comprising both patterns with sharp edges and patterns with blurred edges.

Display system 500 of FIG. 5 comprises the same elements as display system 100 of FIG. 1. Projector 108 for example is a vector scan projector. System 500 further comprises, between projector 108 and film 106, a transmissive diffuser 501 which may be activated/deactivated by electric control, for example, a liquid crystal diffuser of PDLC type, PDLC standing for “Polymer Dispersed Liquid Crystal”. In other words, diffuser 501 transmits, by diffusing it, the light illuminating its surface directed towards projector 108, when it is activated by means of an adapted electric control signal, and transmits the light without diffusing it when it is deactivated. Diffuser 501 thus forms a blurring element which may be electrically activated/deactivated, enabling to transform patterns with sharp edges generated by projector 108 into patterns with blurred edges. In the shown example, diffuser 501 is arranged to intercept the entire beam of light rays emitted by projector 108 towards film 106.

To display both patterns with sharp edges and patterns with blurred edges on film 106, it may be provided to project an alternation of frames comprising patterns which are desired to be displayed in sharp fashion, and of frames comprising patterns which are desired to be blurred. Each time a frame comprising patterns which are desired to be displayed in sharp fashion is projected, diffuser 501 may be deactivated, and each time a frame comprising patterns which are desired to be displayed in blurred fashion is projected, diffuser 501 may be activated.

Specific embodiments have been described. Various alterations, modifications, and improvements will readily occur to those skilled in the art.

In particular, it will occur to those skilled in the art that the alternative embodiments described in relation with FIGS. 3 to 5 are compatible not only with the embodiment of FIG. 1, as described, but also with the embodiment of FIG. 2.

1. A system for displaying an image on a windshield of a vehicle, comprising:
a stack of first and second films at least partially coating a surface of the windshield, the first film being arranged between the windshield and the second film; and
a projector capable of projecting an image onto the surface of the second film opposite to the windshield, wherein:
the second film is a reflective diffuser screen or a photoluminescent film capable of displaying said image in a first range of visible wavelengths; and
the first film is a reflector capable of reflecting at least 50% and preferably at least 90% of the light transmitted by the second film towards the windshield in said first wavelength range.

2. The system of claim 1, wherein the first and second films are transparent for the light coming from the windshield.

3. The system of claim 1, wherein the second film is a reflective diffuser screen, and wherein the projector emits only in said first wavelength range.

4. The system of claim 1, wherein the second film is a photoluminescent film capable, when it is excited by rays at at least one activation wavelength which does not belong to the first wavelength range, of emitting light only in said first wavelength range, and wherein the projector is capable of emitting at said at least one activation wavelength.

5. The system of any of claim 1, wherein the first film is a holographic film.

6. The system of claim 5, wherein the first film is only reactive to the wavelengths of said first wavelength range, and is transparent for the other wavelengths.

7. The system of any of claim 1, wherein said first wavelength range has a spectral width smaller than 50 nm.

8. The system of any of claim 1, wherein the windshield is an armored windshield.

9. The system of claim 1, wherein the projector is a laser projector.

10. The system of claim 1, further comprising a blurring element arranged between the projector and the second film.

11. The system of claim 10, wherein the blurring element is a permanent diffuser arranged to intercept a portion only of a beam projected by the projector onto the second film.

12. The system of claim 10, wherein said blurring element is a diffuser which may be activated and deactivated by electric control, arranged to totally intercept a beam projected by the projector onto the second film.
